(19) United States
(12) Patent Application Publication
(10) Pub. No.: US 2004/0125809 A1
(43) Pub. Date: Jul. 1, 2004

(54) Ethernet interface over ATM Cell, UTOPIA xDSL in single and multiple channels converter/bridge on a single chip and method of operation

(76) Inventor: Jack Ing Jeng, Arcadia, CA (US)

Correspondence Address: SNELL & WILMER, ONE ARIZONA CENTER, 400 EAST VAN BUREN, PHOENIX, AZ, 850040001

(21) Appl. No.: 10/334,604

(22) Filed: Dec. 31, 2002

(51) Int. Cl. H04L 12/28

(52) U.S. Cl. 370/395.53

(57) ABSTRACT

The present invention relates to a converter/bridge between an Ethernet bus and a UTOPIA bus in single or multiple channels. The converter/bridge includes a first conversion device and a second conversion device for converting Ethernet packet into ATM cells and for converting ATM cells into Ethernet packet. The first conversion device includes a first conversion unit, a combining unit and a first transmitting unit. And the second conversion device includes a receiving unit, a second conversion unit and a second transmitting unit. The present invention provides a low cost and efficient transport between the Ethernet and ATM networks.

### FIELD OF THE INVENTION

This invention relates to the field of Ethernet switching/transmission domain to ATM Cell switching/transmission world and in particular, a circuit converter/bridge between Ethernet Frame/Bus to UTOPIA Cell/bus in single or multiple channels.

### BACKGROUND OF THE INVENTION

Ethernet is the most widely used Local Area Network (LAN) technology. Ethernet provides a low-cost, high-speed, general-purpose interface for users sharing information. Switching offers a way of using the Ethernet standard that greatly increases its performance without requiring changes to network adapters or computer software.

An Ethernet switch is a device with multiple Ethernet connections, or ports. The Ethernet switch needs higher speed ports for file server or backbone connections via Fast Ethernet, or ATM. The Ethernet switch can be scalable up to 10-giga-bit, Gigabit ,100-Mega bit switching system by cascading or hierarchy tree structure or daisy-chained topology. The term “switch” is usually reserved for a device that has many Ethernet ports, all or most of which can accept or transmit packets simultaneously at the full rate of the connected LAN media.

An Ethernet switch interconnects a large number of ports moving packets of data between ports entirely by electronic logic. Microprocessors and software do not participate in basic data movement. Ethernet switching procedures can be encapsulated entirely within Application-Specific Integrated Circuits (ASICs). Bridges and routers, in contrast, typically use high performance RISC microprocessors to move data packets. Packet movement by microprocessor is either more expensive or slower, and requires larger devices, larger cabinets for a given number of Ethernet segments, and more electric power.

FIG. 1 shows the Ethernet packet structure. In order to maintain correct operations of the Carrier Sensitive Multi-Access/Collision Detection (CSMA/CD), the Ethernet packets are spaced out between each other for at least 96 bits 21. The packet starts with a 56-bit synchronization preamble string 23, and then followed by 8-bits of start frame delimiter, 48-bits of destination address 25, 48-bit of source address 27, and then a 16-bit type field 29. The rest of the packet is the payload 31, and then the CRC error-checking code 33. The main advantage of the Ethernet is its simplicity and flexibility. The variable packet sizes make it easy to adjust the transmission flow, in response to the rapid change of network workload conditions. The full-distributed nature of the Ethernet makes it possible to build an unmanaged LAN at very low costs.

The Asynchronous Transfer Mode (ATM) protocol is a connection-oriented protocol that is ideal for voice, video and data communications. ATM is a network technology based on transferring data in cells or packets of a fixed size. The cell used with ATM is relatively small compared to units used with older technologies.

ATM creates a fixed channel, or route, between two points whenever data transfer begins. This differs from TCP/IP, in which messages are divided into packets and each packet can take a different route from source to destination. This difference makes it easier to track and bill data usage across an ATM network, but it makes it less adaptable to sudden surges in network traffic.

ATM cells from multiple sources and multiple destinations are asynchronously multiplexed between multiple packet switches. Every circuit on each link of the network is identified by unique integer fields called the Virtual Path Identifier (VPI) and Virtual Circuit Identifier (VCI). ATM switches are responsible for switching cells between ports, buffering cells, translating VPI/VCI's, guaranteeing QOS, connection set-up, and connection tear-down.

FIG. 2 shows the structure of an ATM cell. Each cell is 53 bytes long, with 5 bytes reserved for the packet header and 48 bytes reserved for the payload. The header begins with 4 bits of generic flow control (GFC) 41 information. This field is used to ensure fair and efficient access between multiple devices sharing a single User-Network Interface (UNI). Following the GFC 41 field is an 8-bit virtual path identifier (VPI) 43, and a 16-bit virtual channel identifier (VCI) 45. The VPI 43 allows a group of virtual connections, called a virtual path, to be identified and the VCI 45 identifies the individual virtual connections within each virtual path.

Following the VPI/VCI information is the 3-bit payload type (PT) 47 field. The first bit indicates user or control data. If the first bit indicates user data, the middle bit indicates congestion, and the last bit indicates the end of frame. The next field is the 1-bit cell loss priority (CLP) 49 bit permits two priorities of cell to be defined where the network may discard low priority cells under congestion conditions. The header error check (HEC) 51 field provides an 8-bit redundancy check on the contents of the cell header.

The UTOPIA (Universal Test and Operations PHY Interface for ATM) interface is defined by the ATM Forum to provide a standard chip-level interface between ATM devices and ATM PHY or SAR (segmentation and Re-assembly) device. The UTOPIA interface has an 8-bit data bus and includes FIFOs that are able to store ATM cells in transmitting and receiving direction. It supports cell level handshaking and optionally parity bit generation and checking. The UTOPIA interface implements a full duplex bus with separate data and control signals in both directions.

ATM Cell switching is very popular in the Digital Subscriber Line (xDSL) system (last mile, up to 9 km). xDSL technology is a means by which plain old telephone service (POTS) can be used to send ATM cells over a pair of copper wires to the central station of a phone company. ATM over xDSL offers high-speed network access from the home and small office environment. Several standards are being developed in these areas, including asymmetric digital subscriber line (ADSL), universal ADSL (UADSL), G.SHDSL (Symmetric High-speed DSL) and VDSL (Very high speed DSL). These technologies use the local loop, the copper wires that connect the local central office in a user's neighborhood to the customer's phone jack. In many areas, this local loop connects directly to an ATM core network run by a telephone company. ATM over xDSL service preserves the high-speed characteristics and QoS guarantees available in the core ATM network without changing protocols. This creates the potential for an end-to-end ATM network to the residence or small office.

FIG. 3 shows an xDSL services delivery architecture. In xDSL, Digital Subscriber Line Access Multiplexer (DSLAM) 751 is used to deliver broadband Internet access. The function of DSLAM 751 is to aggregate digital data traffic from xDSL 73 before it is transferred to an ATM switch or Internet Protocol (IP) router 753. A typical DSLAM supports a couple of hundred xDSL channels per shelf (a single rack mount chassis). On the network side are one or more trunk lines that carry the multiplexed traffic from the DSLAM to a switch or router, which is in turn connected to the Internet 77. Therefore in the DSLAM 751 side needs an even more powerful CPU to handle large amount of channels.

For xDSL system, it has to pack and unpack the ATM cells to and from the IP/Ethernet packet. This implies that it needs an expensive RISC CPU and huge memory to process these cells. CPU of the central office side has to handle the complicated ATM protocol of large amount of channels. Furthermore, the rapid increase in computing power, computing resources and the requirement to interconnect these computing environments led to a requirement for faster networks. These requirements led to the development and standardization of a 100 Mb/s Ethernet and even a Gigabit Ethernet. Gigabit Ethernet provides all the familiarity of Ethernet, at 1,000,000,000 bits per second.

Therefore, there exists a demand for simple and fast converter/bridge between the Ethernet Packets to ATM UTOPIA interface, in single channel for the Customer Premises Equipment (CPE) and multiple channels for the DSLAM side. Specially for the DSLAM side, an ASIC based device that can convert multiple Ethernet Channels to the corresponding xDSL channels is very much demanded for a large scale Ethernet switching system over xDSL network.

### SUMMARY OF THE INVENTION

One aspect of the present invention is to provide an Ethernet interface over xDSL, UTOPIA, ATM cell converter/bridge and method of operator. Another aspect of the present invention is to provide a converter/bridge between Ethernet bus to UTOPIA bus in single or multiple channels. A further aspect of the present invention is to provide a single-chip solution, which is aimed at providing a low cost transport between the Ethernet and ATM networks.

The present invention relates to a converter/bridge coupled to Ethernet bus interface and UTOPIA bus interface via a first bus and a second bus. The converter/bridge includes a first conversion device and a second conversion device. The first conversion device is used for receiving and converting an Ethernet data packet over the first bus into 53-byte ATM cells over the second bus. The second conversion device is used for receiving and converting 53-byte ATM cells over the second bus into Ethernet data packet over the first bus.

The first conversion device further includes a first conversion unit for converting Ethernet data packet into sub-cell data field, an ATM Cell Buffer unit for combining a group of sub-cell data field and inserting the Cell Signal byte in the header field of the ATM cell into a 53-byte ATM cell, and a transmitting unit for transmitting the 53-byte ATM cell in ATM cell format. The second conversion device further includes a receiving unit for detecting the Cell Signal Byte in the first byte of the ATM Cell Header field, a conversion unit for converting Signal Bit to the RXDV signal of Ethernet MII bus and converting associated data nibbles to the RXDA of the Ethernet MII bus, and a transmitting unit for transmitting the Ethernet data packet in Ethernet packet format.

The present invention also relates to a method of converting Ethernet data packets into ATM cells and converting ATM cells into Ethernet data packet. The method includes the following steps. First, receiving and converting an Ethernet data packet over a first bus into 53-byte ATM cells over a second bus. Then, receiving and converting 53-byte ATM cells over the second bus into Ethernet data packet over the first bus.

The present invention also relates to a method of controlling the data flow from the MAC transmit buffer by using on-and-off scheme to the TX_CLK to slow down the Ethernet transmit speed due to the relatively slow speed of the xDSL/ATM/UTOPIA transmission.

The present invention also relates to a method of controlling the data flow to the MAC receiving buffer by using on-and-off scheme to the RX_CLK to slow down the Ethernet transmit speed due to the relatively slow speed of the xDSL/ATM/UTOPIA transmission.

The present invention provides a USB to UTOPIA converter/bridge, including a USB to Ethernet bridge connecting Ethernet MI bus to USB 1.1/2.0.

### BRIEF DESCRIPTION OF THE DRAWINGS

FIG. 1 shows the structure of Ethernet packet;

FIG. 2 shows the structure of ATM cell;

FIG. 3 shows xDSL services delivery architecture;

FIG. 4 shows an embodiment of the present invention;

FIG. 5 shows Ethernet MAC_PHY bus interface standard;

FIG. 6 shows an overview of Ethernet Frames converting to UTOPIA(ATM) cells;

FIG. 7 shows an overview of UTOPIA(ATM) cells converting to Ethernet Frames;

FIG. 8(a), 8(b) show of flow controlled TX_CLK scheme of transmission path and reception path;

FIG. 9(a), 9(b) show another example of flow controlled TX_CLK scheme of transmission path and reception path;

FIG. 10 shows an embodiment of the present invention of UTOPIA to MII interface;

FIG. 11 shows an embodiment of the present invention which couples to Ethernet bus interface and UTOPIA bus interface in single channel;

FIG. 12 shows an embodiment of the present invention which couples to Ethernet bus interface and UTOPIA bus interface in multiple channels;

FIG. 13 shows a block diagram of an Ethernet to UTOPIA/VDSL design using the off-the-shelf-component;

FIG. 14 shows another block diagram of an Ethernet to UTOPIA/VDSL design using the off-the-shelf-component; and

FIG. 15 shows another embodiment of the present invention extend the Ethernet interface to USB interface so that the converter/bridge is an USB interface to UTOPIA bus converter/bridge.

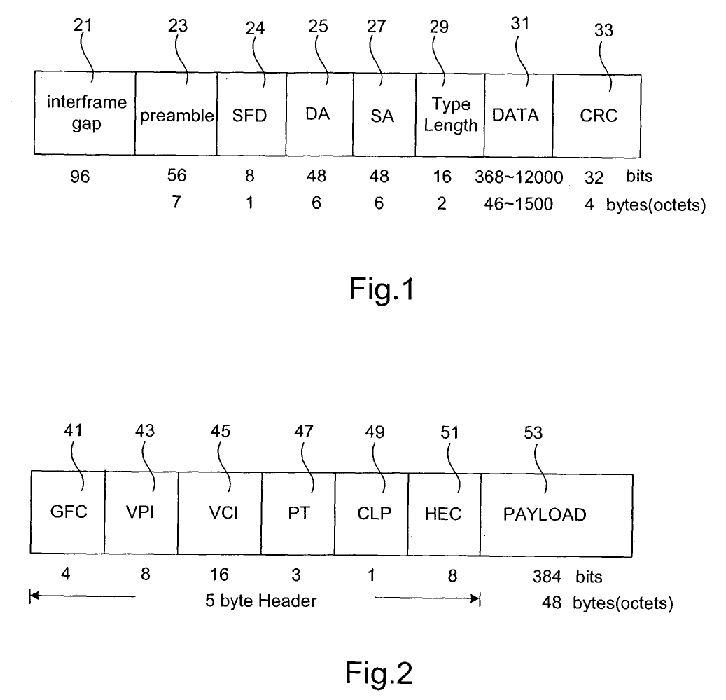

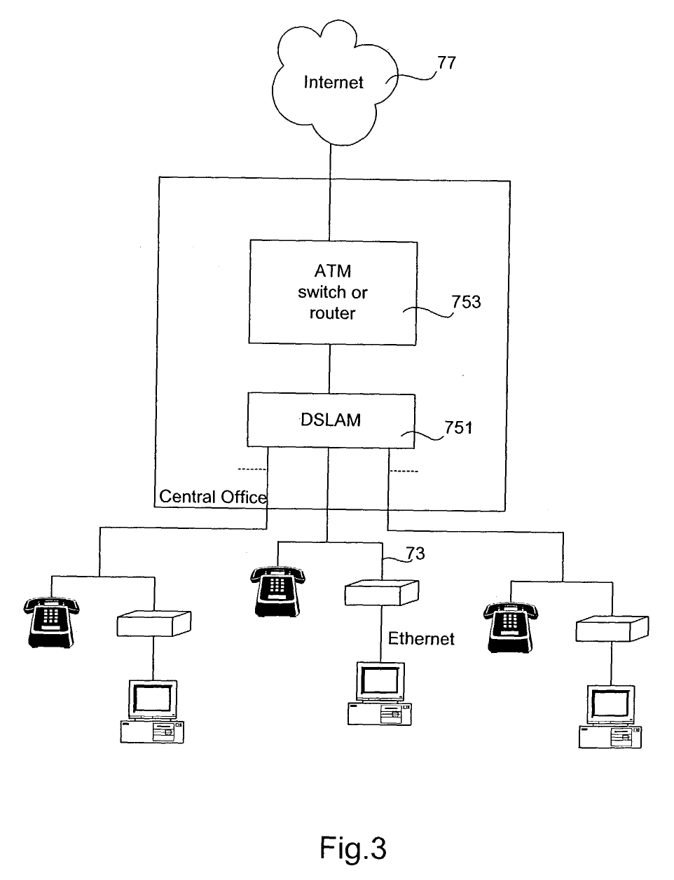

### DETAILED DESCRIPTION OF THE INVENTION

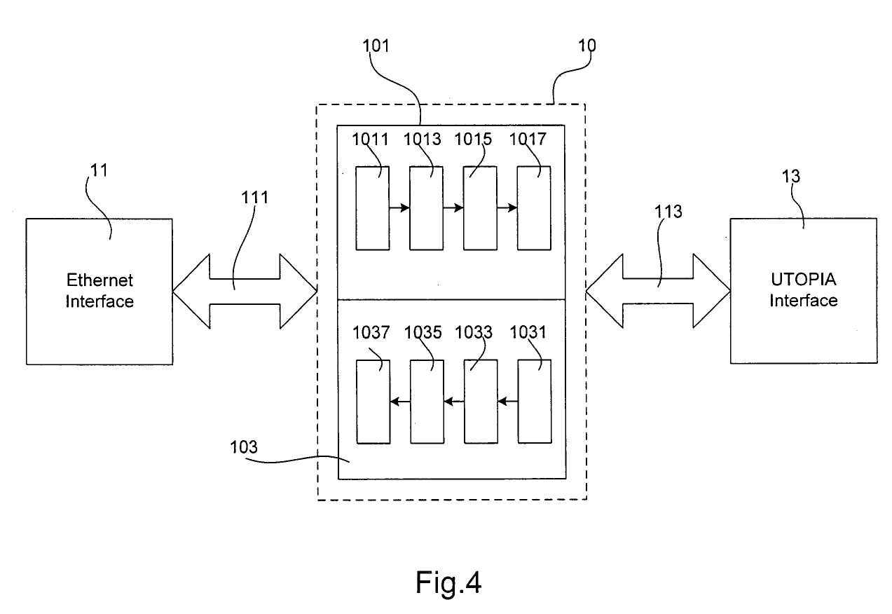

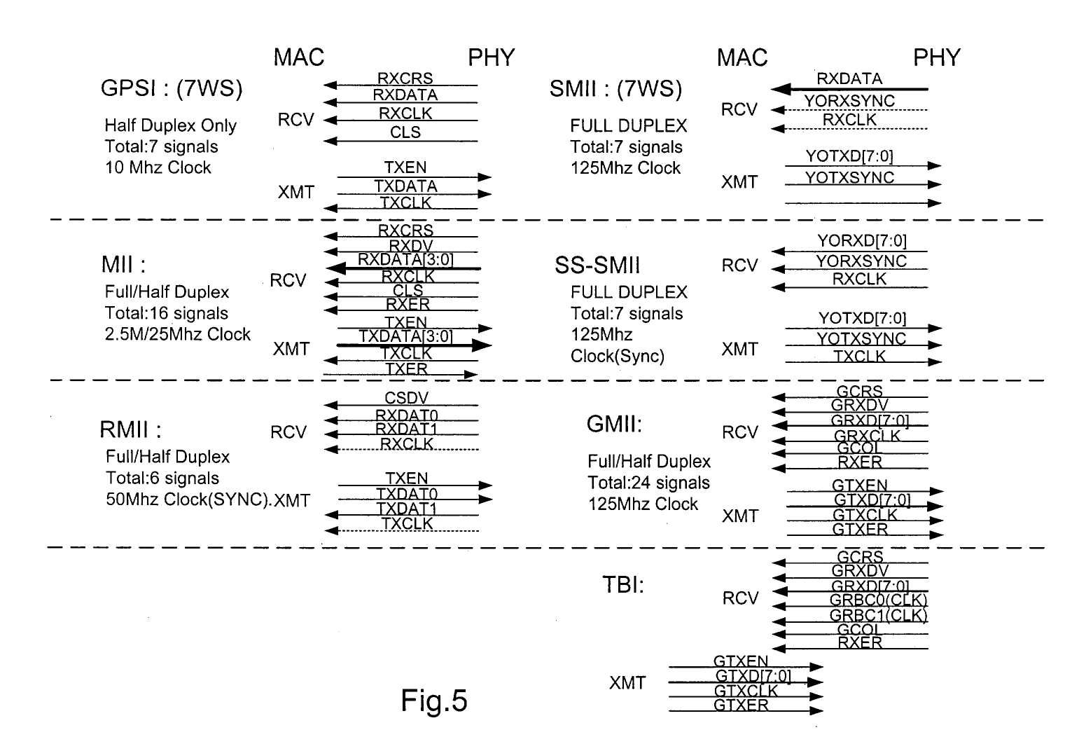

The present invention relates to a converter/bridge between Ethernet interface bus to UTOPIA interface bus. FIG. 4 shows, in simplified block diagram form, an embodiment of the present invention. The converter/bridge 10 respectively couples to Ethernet bus interface 11 and UTOPIA bus interface 13 via an Ethernet bus 111 and a UTOPIA bus 113. The converter/bridge 10 includes a first conversion device 101 and a second conversion device 103. The first conversion device 101 receives and converts Ethernet data packet over the Ethernet bus 111 into 53-byte ATM cells over UTOPIA bus 113. The second conversion device 103 receives and converts 53-byte ATM cells over the UTOPIA bus 113 into Ethernet data packet over Ethernet bus 111. In addition, the Ethernet bus interface is selected form GPSI, MII, RMII, SMII, GMII, SS-SMII, TBI and other Ethernet interfaces. The Ethernet MAC_PHY bus interface standard is shown in FIG. 5. UTOPIA bus interface is selected from UTOPIA level 1, Level 2, Level 3, and level 4 bus.

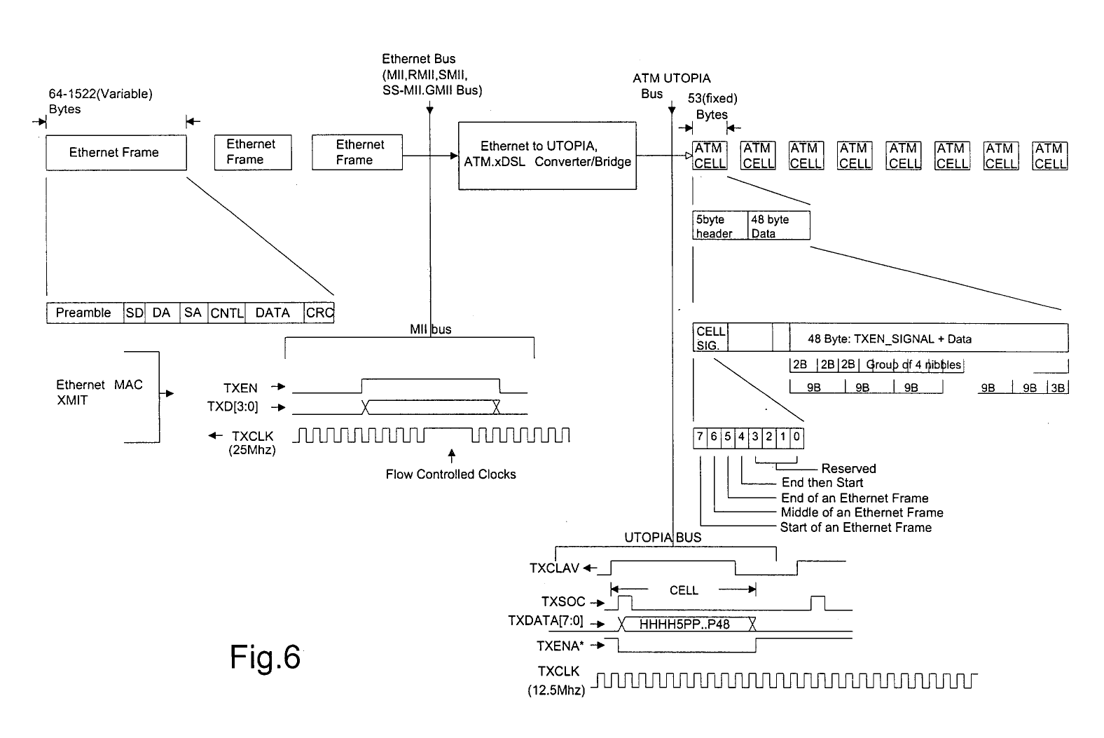

Furthermore, the first conversion device 101 includes a conversion unit 1011 and an ATM Cell Buffer unit 1013, a transmitting unit 1015 and a TX_CLK flow controlled clock unit 1017. The conversion unit 1011 is used for converting the Ethernet data packets into 4-nibble sub-cell data field, each 4-nibble sub-cell data field including a 3-nibble data field and an associated signal nibble. The signal bit is the TXEN (transmit Enable signal bit) in the MI/Ethernet Bus. And the Data field nibble is the TXDATA [3:0] (transmit Data bit 3-0.) The associated signal nibble indicates the presence of the associated_data field in the Ethernet Bus. The overview of Ethernet Frames to UTOPIA (ATM) cell transmission path is shown in FIG. 6 which depicts how the Ethernet frames are converted to ATM cells. The ATM Cell Buffer unit 1013 is used for combining a group of twenty-four multiple 4-nibble sub-cell data field and inserting the Cell Signal byte in the header field of the ATM Cell into a 53-byte ATM cell. The header further has an unused data field for out band management conveying the status and controlling local and remote node. The transmitting unit 1015 is used for transmitting the 53-byte ATM cell in ATM cell format.

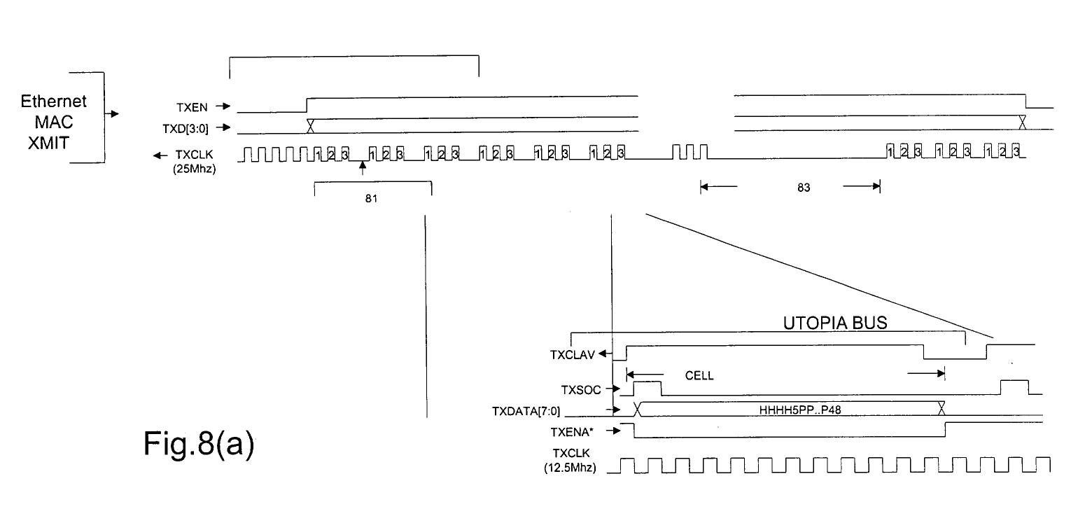

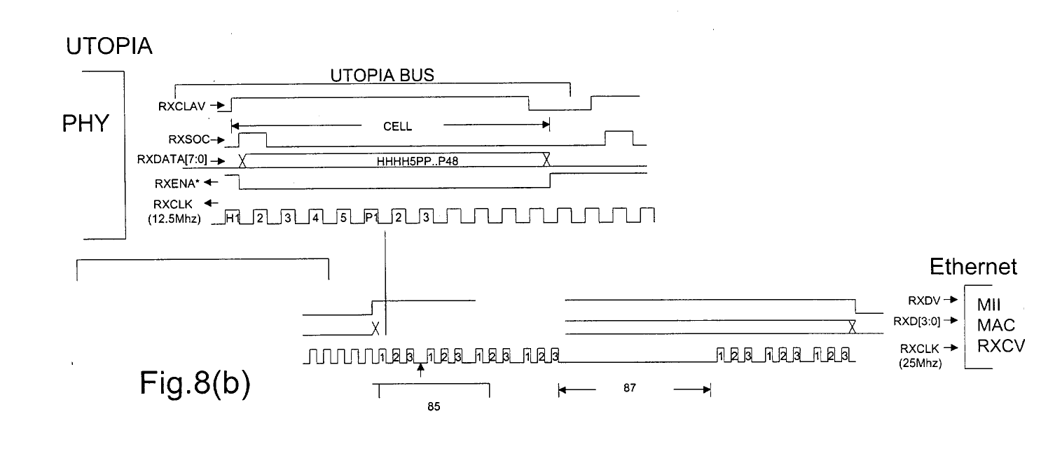

The flow control Clock 1017 is to slow down the Ethernet transmission speed due to slower speed in the xDSL transmission. The Ethernet MII TX_CLK clock rate shall be running at 25 Mhz speed. With 4-bit (Nibble wide) XDATA [3:0]] data bus, the nominal speed of interface 111 is running at 100 Mbps. The UTOPIA bus shall be running at 12.5 Mhz clock rate. With 8-bit wide of the UTOPIA bus the speed of interface 113 is also running at 100 Mbps. This clock rate scheme results in simplifying the buffer management. Furthermore, of the flow control that when 1011 inserting the Signal nibble, this will add 25% of the signaling overhead. So the TX_CLK shall pause for one 25 Mhz Clock cycle 81 after receiving 3 nibbles of Ethernet data field as shown in FIG. 8(a). This results in both Ethernet MI bus and UTOPIA bus running at 100 Mbps with 25% signal nibble overhead. The actual data transmission is 75 Mbps. Furthermore, for the flow control scheme in the situation when UTOPIA stops sending the TXCLAV (Transmit Cell Available) to the interface 113, this means that previous xDSL/ATM cell has not been completely transmitted. This will result in a buffer full situation of 1013. When this happens, the flow control Clock 1017 shall further pause the TX_CLK (25 Mhz clocks) 83 until the ATM Cell Buffer unit 1013 has at least one cell buffer to be transmitted to interface 113. Since the header field of the ATM cell has limited utilization by the ATM forum so only the first byte of the header been used as the Cell Signal byte indicating the Cell data has the Ethernet data field as depicted in the FIG. 6.

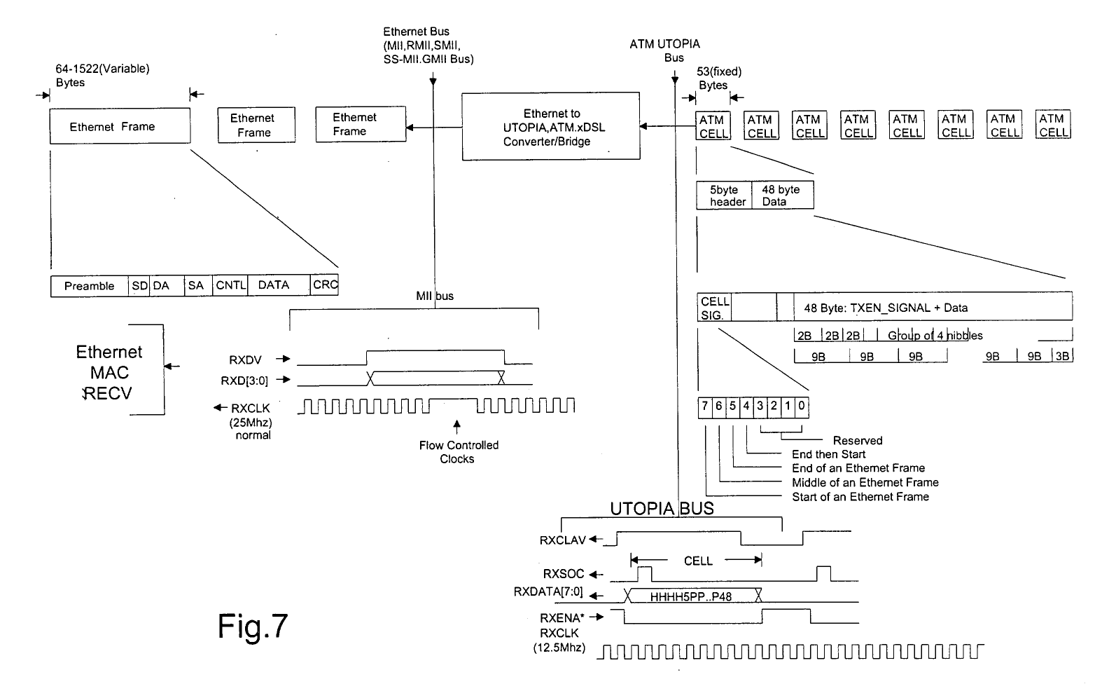

The second conversion device 103 also includes a receiving unit 1031, a conversion unit 1033, a transmitting unit 1035, and a RX_CLK flow controlled clock unit 1037. The receiving unit 1031 detects the Cell Signal Byte in the first byte of the ATM Cell Header field and sends only the ATM Cell data (48 bytes) to conversion unit 1033 Cell buffer. The Cell Data is composed of twenty-four multiple 4-nibble sub-cell data field, each 4-nibble sub-cell data field including a 3-nibble data field and an associated signal nibble ahead. The conversion unit 1033 converts the Signal Bit to the RXDV (Receive Data Available) signal of Ethernet MII bus and converts the associated data nibbles in the following data byte to the RXDA [3:0] (Receive Data bit 3-0) of the Ethernet MII bus. The transmitting unit 1035 is used for transmitting the Ethernet data packet in Ethernet packet format. An overview of UTOPIA (ATM) cell reception path is shown in FIG. 7 which depicts how the ATM cells are converted to the Ethernet frames.

The flow control Clock 1037 is to slow down the Ethernet receiving speed due to slower speed in the xDSL reception. The Ethernet MII RX_CLK clock rate shall be running at 25 Mhz speed. With 4-bit (Nibble wide) RDATA [3:0] data bus, the nominal speed of interface 311 is running at 100 Mbps. The UTOPIA bus shall be running at 12.5 Mhz clock rate. With an 8-bit wide UTOPIA bus, the speed of interface 113 is also running at 100 Mbps. This clock rate scheme results in simplifying the buffer management. Furthermore, in the case what the flow control conversion unit 1033 is striping the Signal nibble, this will cut 25% of the Ethernet Bus Receiving speed. So the RX_CLK shall pause for one 25 Mhz Clock cycle 85 after receiving 3 nibbles of Ethernet data field as shown in FIG. 8(b). This result in that Ethernet MII bus is running at 75 Mbps speed while the UTOPIA bus is running at 100 Mbps. Furthermore, for the flow control scheme when UTOPIA stops sending the RXCLAV (Receive Cell Available) to the bus 113, this means that no complete xDSL/ATM cells has been received yet. This will result-in buffer empty situation of 1033. When this happens, the clock unit 1037 shall further pause the RX_CLK (25 Mhz clocks) until the conversion unit 1033 has at least one cell buffer 87 to be transmitted to interface 113.

Another embodiment of the present invention further provides an embodiment, including a first conversion device and a second conversion device. The first conversion device has includes a conversion unit 1011 and an ATM cell Buffer unit 1013, a transmitting unit 1015, and TX_CLK flow controlled clock unit 1017. Similarly, the conversion unit 1011 is used for converting the Ethernet data packets into 9-byte sub-cell data field, each 9-byte sub-cell data field including an 8-byte data field and an associated signal byte. The associated signal byte indicates the presence of the associated data field in Ethernet Bus as shown in FIG. 6. The ATM Cell Buffer unit 1013 is used for combining a group of five multiple 9-byte packets with a 5-byte of header and 3 reserved bytes into a first 53-byte ATM cell. The reserved bytes are used for out band management conveying the status and controlling local and remote node. The transmitting unit 1015 is used for transmitting the 53-byte ATM cell in ATM cell format.

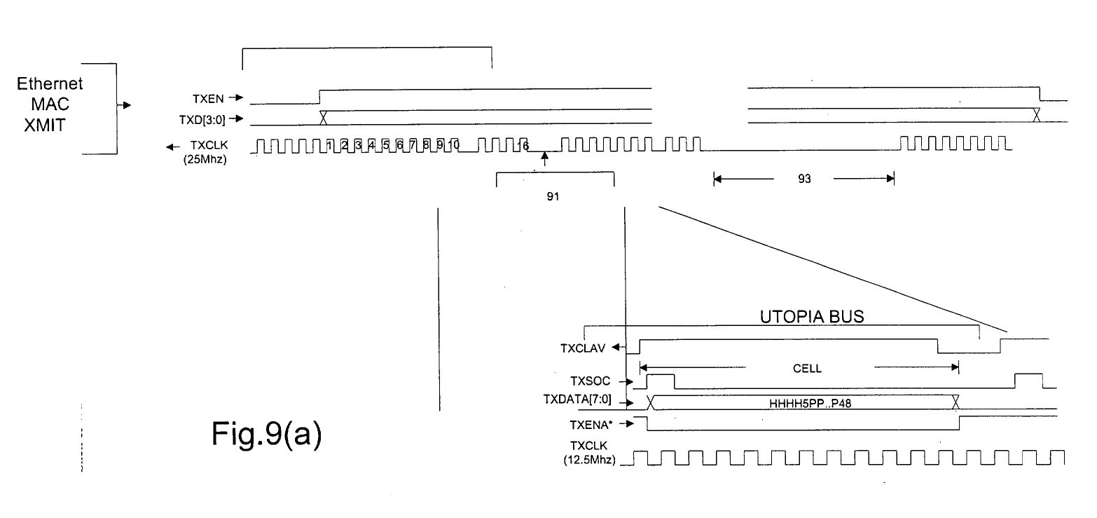

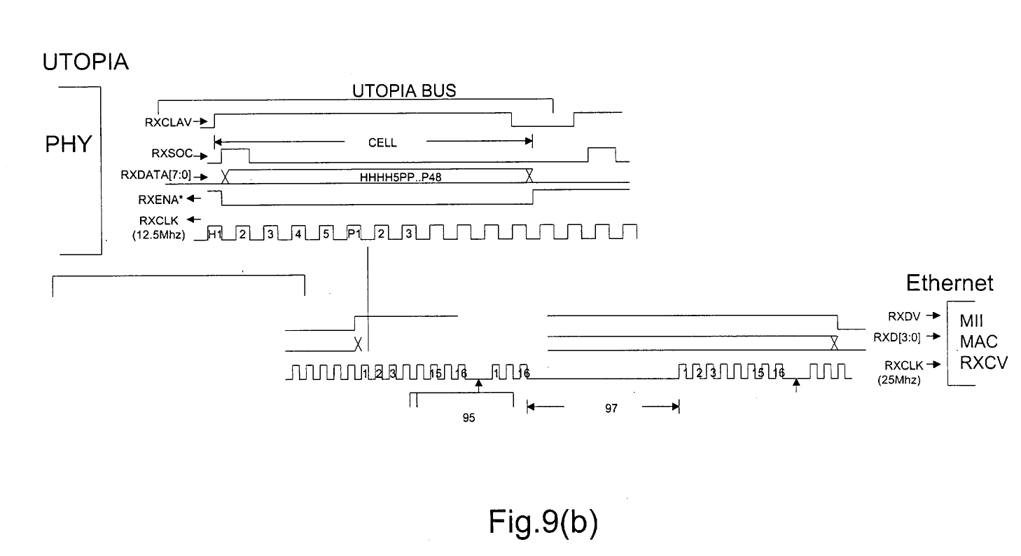

The flow control Clock 1017 is to slow down the Ethernet transmission speed due to slower speed in the xDSL transmission. The Ethernet MII TX_CLK clock rate shall be running at 25 Mhz speed. With 4-bit (nibble wide) XDATA [3:0] data bus, the nominal speed of interface 111 is running at 100 Mbps. The UTOPIA bus shall be running at 12.5 Mhz clock rate. With 8-bit wide of the UTOPIA bus the speed of interface 113 is also running at 100 Mbps. This clock rate scheme results in simplifying the buffer management. Furthermore, of the flow control situation when conversion unit 1011 is inserting the Signal nibble, this will add 12.5% of the signaling overhead. So the TX_CLK shall pause for two 25 Mhz Clock cycles 91 after receiving 16 nibbles of Ethernet data field as shown in FIG. 9(a). This results in both Ethernet MII bus and UTOPIA bus running at 100 Mbps with 12.5% signal nibble overhead. The actual data transmission is 75 Mbps. Furthermore, for the flow control scheme when UTOPIA stops sending the TXCLAV (Transmit Cell Available) to the interface 113, this means that previous xDSL/ATM cells has not been completely transmitted. This will result in a buffer full situation of 1013. When this happened, the flow control Clock 1017 shall further pause the TX_CLK (25 Mhz clocks) 93 until the ATM Cell Buffer unit 1013 has at least one cell buffer to be transmitted to interface 113. Since the header field of the ATM cell has limited utilization by the ATM forum so only the first byte of the header has been used as the Cell Signal byte indicating the Cell data has the Ethernet data field as depicted in the FIG. 6.

The second conversion unit 103 also includes a receiving unit 1031, a conversion unit 1033, a transmitting unit 1035 and RX_Clk flow controlled clock unit 1037. The receiving unit 1031 of second conversion unit is used for detecting the Cell Signal Byte in the first byte to the ATM Cell Header field and sending only the ATM Cell data to ATM Cell buffer. The Cell Data is composed of five multiple 9-byte data fields, a 5-byte header and, 3 reserved bytes. Each 9-byte data field including an 8-byte data field and an associated signal byte. The conversion unit 1033 is used for converting ATM cell data into Ethernet data packet. The transmitting unit 1035 is used for transmitting the Ethernet data packet in Ethernet packet format.

The flow control Clock 1037 of the embodiment is to slow down the Ethernet receiving speed due to slower speed in the xDSL reception. The Ethernet MII RX_CLK clock rate shall be running at 25 Mhz speed. With 4-bit (nibble wide) RDATA [3:0]] data bus, the nominal speed of interface 311 is running at 100 Mbps. The UTOPIA bus shall be running at 12.5 Mhz clock rate. With 8-bit wide of the UTOPIA bus the speed of interface 113 is also running at 100 Mbps. This clock rate scheme results in simplifying the buffer management. Furthermore, of the flow control that results when conversion unit 1033 is striping the Signal nibble, this will cut 12.5% of the Ethernet Bus Receiving speed. So the RX_CLK shall pause for two 25 Mhz Clock cycles 95 after receiving 16 nibbles of Ethernet data field as shown in FIG. 8(b). This results in that Ethernet MII bus is running at 75 Mbps speed while the UTOPIA bus is running at 100 Mbps. Furthermore, for the flow control scheme that results when UTOPIA stops sending the RXCLAV (Receive Cell Available) to the bus 113, this means that no complete xDSL/ATM cell has been received yet. This will result in buffer empty situation of unit 1033. When this happens, the clock unit 1037 shall further pause the RX_CLK (25 Mhz clocks) until the conversion unit 1033 has at least one cell buffer 97 to be transmitted to interface 113.

For improving the performance of the converter/bridge between Ethernet interface bus to UTOPIA interface bus, the present invention may trim the preamble and the start frame delimiter of an Ethernet packet when receiving the Ethernet packet from the Ethernet MAC. The present invention only transmits the destination address, source address, type field, payload, and the CRC of the Ethernet packet over UTOPIA bus. Additionally, when receiving a packet from UTOPIA, the present invention adds the preamble and the start frame delimiter in front of the receiving frame and transmits to Ethernet bus. This will improve the performance by 12.5% (8/64).

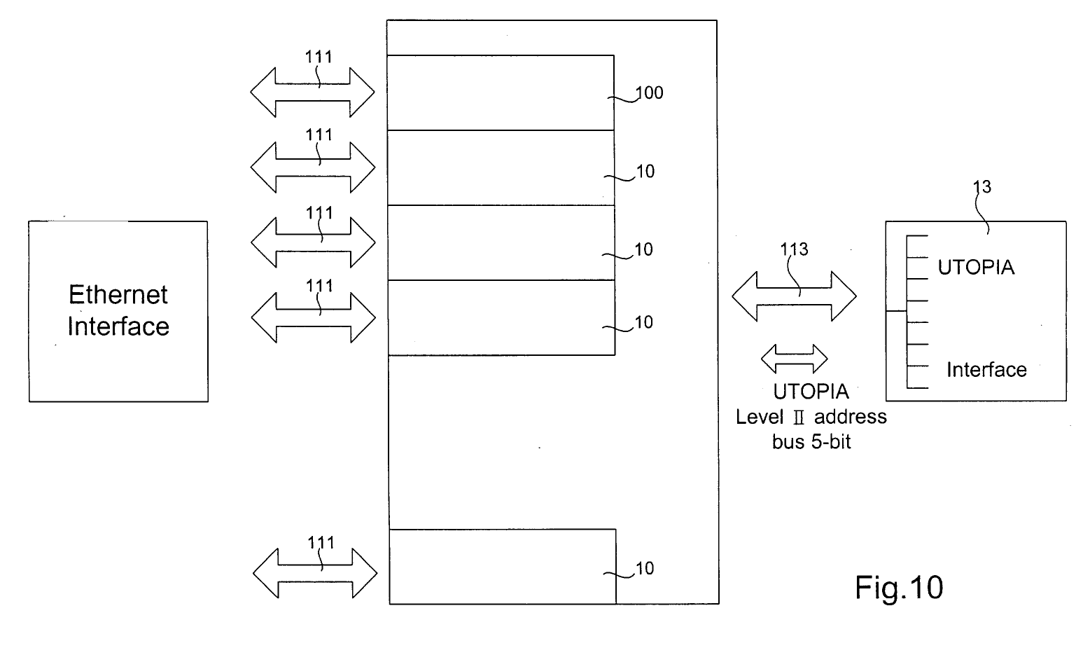

FIG. 10 shows another embodiment of the present invention coupled UTOPIA bus interface via multiple first buses 111. Matching the address of UTOPIA level 2, level 3, and level 4 interface, the present invention supporting multiple channels, up to 32 channels, further including an address decision unit on UTOPIA bus 100 for distinguishing a proper first bus to transmit Ethernet data packets.

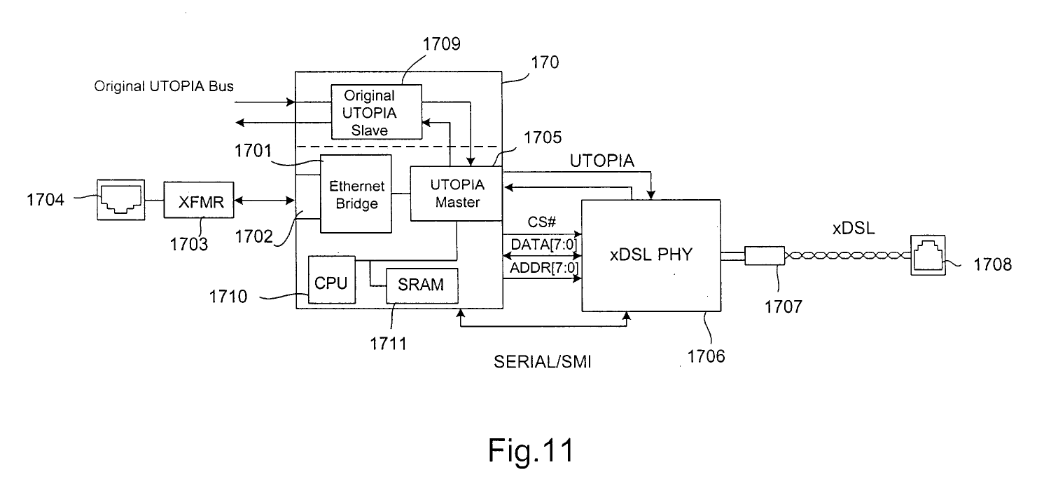

FIG. 11 shows an embodiment of the present invention which couples to Ethernet bus interface and UTOPIA bus interface in single channel. In the embodiment, the converter/bridge 170 is made up in a single chip. The converter/bridge of the present embodiment includes an Ethernet bridge 1701 and an Ethernet PHY device 1702. The Ethernet bridge 1701 controls data packets within a subnet in an attempt to cut down the amount of traffic. The Ethernet PHY device 1702 provides the physical layer interface to one standard Ethernet nodes connected over wiring appropriate for standard Ethernet. An Ethernet transformer device 1703 is used to provide the transformer circuits and couple signals between a connector 1704 and the PHY device 1702.

The converter/bridge 170 also includes a UTOPIA master 1705, a xDSL PHY 1706 and a UTOPIA slave buffer 1709. The UTOPIA master 1705 is responsible to initiate and control data transfers from and to the UTOPIA slave buffer 1709, xDSL PHY 1706 and the Ethernet bridge 1701. The xDSL PHY device 1706 provides the

physical layer interface to one standard xDSL node connected over wiring appropriate for standard xDSL.

The UTOPIA buffer 1709 is responsible to receive data from original UTOPIA. The UTOPIA slave buffer can ride on existing ATM transmission. The present invention allows data stream transmitting between UTOPIA interfaces by the UTOPIA buffer 1709 coupled to original ATM UTOPIA bus. The UTOPIA master 1705 handles the original ATM UTOPIA bus and the converter UTOPIA bus. The UTOPIA master 1705 transmits original ATM cells and converts Ethernet packets to the UTOPIA bus. A xDSL transformer device 1707 is used to provide the transformer circuits and couple signals between a connector 1708 and the PHY device 1706. In addition, the embodiment also includes a processor 1710 and SRAM 1711 for maintaining the status and the commands of the UTOPIA master 1705.

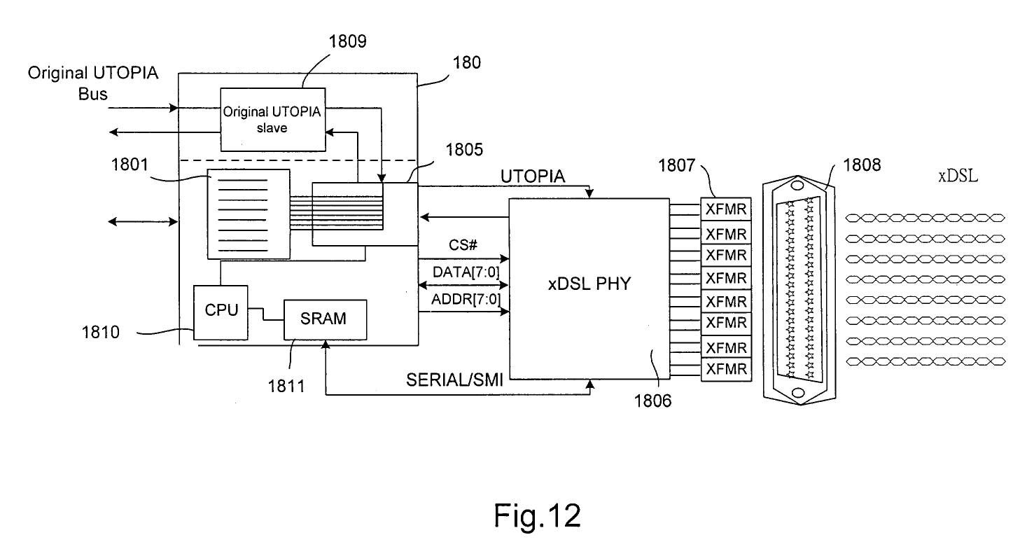

FIG. 12 shows an embodiment of the present invention in which converter/bridge 180 couples to Ethernet bus interface and UTOPIA bus interface in multiple channels. For example, there are 8 channels in the embodiment. In this embodiment, the converter/bridge 180 is made up of 8 channels in a single chip. The embodiment of the present invention includes an Ethernet bridge of 8 channels 1801. The embodiment 180 also includes a UTOPIA master 1805, a xDSL PHY 1806 that multiplexed 8 channels of ATM cells buffer. The UTOPIA master 1805 is responsible to initiate and control data transfers from and to the UTOPIA slave buffer 1809, xDSL PHY 1806 and the Ethernet bridge 1801. The xDSL PHY device 1806 provides the physical layer interface to one standard xDSL node connected over wiring appropriate for standard xDSL.

The UTOPIA slave buffer 1809 is responsible to receive data from original ATM UTOPIA. The UTOPIA slave buffer 1809 can ride on existing ATM transmission. The present invention allows data stream transmitting between UTOPIA interfaces by the UTOPIA buffer 1809 coupled to original ATM UTOPIA bus. The UTOPIA master 1805 handles the original UTOPIA bus and the converter UTOPIA bus. The UTOPIA master 1805 transmits original ATM cells and converts Ethernet packets to the UTOPIA bus. xDSL transformer device 1807 is used to provide the transformer circuits and couple signals between a connector 1808 and the PHY device 1806. In addition, the embodiment also includes a processor 1810 and SRAM 1811 for maintaining the status and the commands of the UTOPIA master 1805. No Ethernet packet buffer is needed because of use of the full duplex mode.

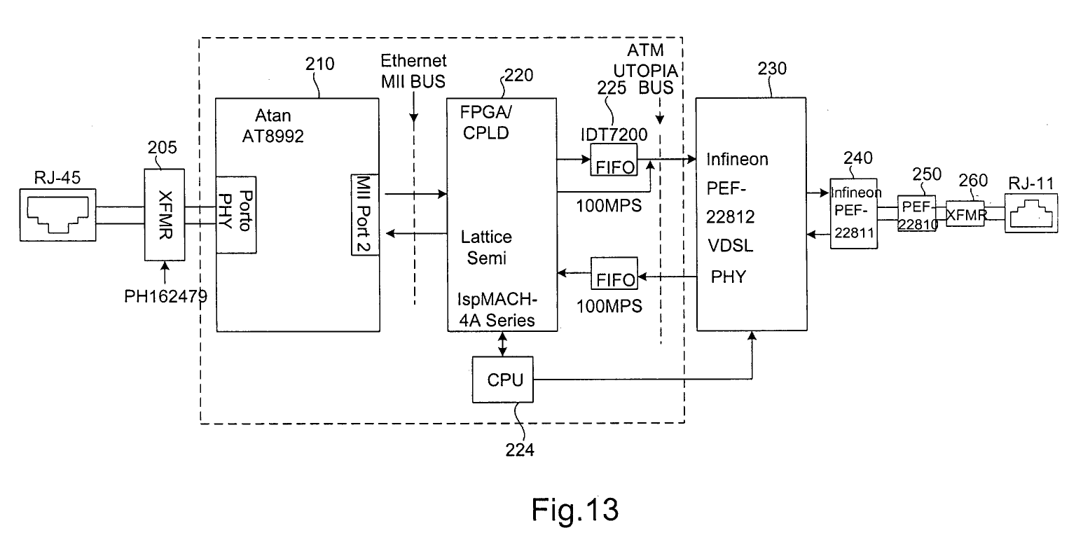

FIG. 13 shows a block diagram of an Ethernet to UTOPIA/VDSL design using the off-the-shelf-components converting Ethernet data packets into 4-nibble sub-cell data field. The Ethernet to UTOPIA/VDSL of this design is provided to make an SOC which integrates FPGA 220, MAC 210, and CPU 224. The transformer for Ethernet 205 is provided by PH162479. The 2-port Ethernet switch 210 is provided by ATAN8992. The MII-to UTOPIA converter 220 is provided by Lattice Semiconductor IspMACH4 series. Two FIFO devices 225 are provided by IDT 7200. The VDSL data pump 230 is provided by Infineon VDSL PEF-22812. The VDSL AFE (analog front end) 240 is provided Infineon VDSL PEF-22812. The VSDL line driver 250 is provided by Infineon VDSL PEF-22810. The transformer for VSAL from APC 260 is provided by APC-77112/77110.

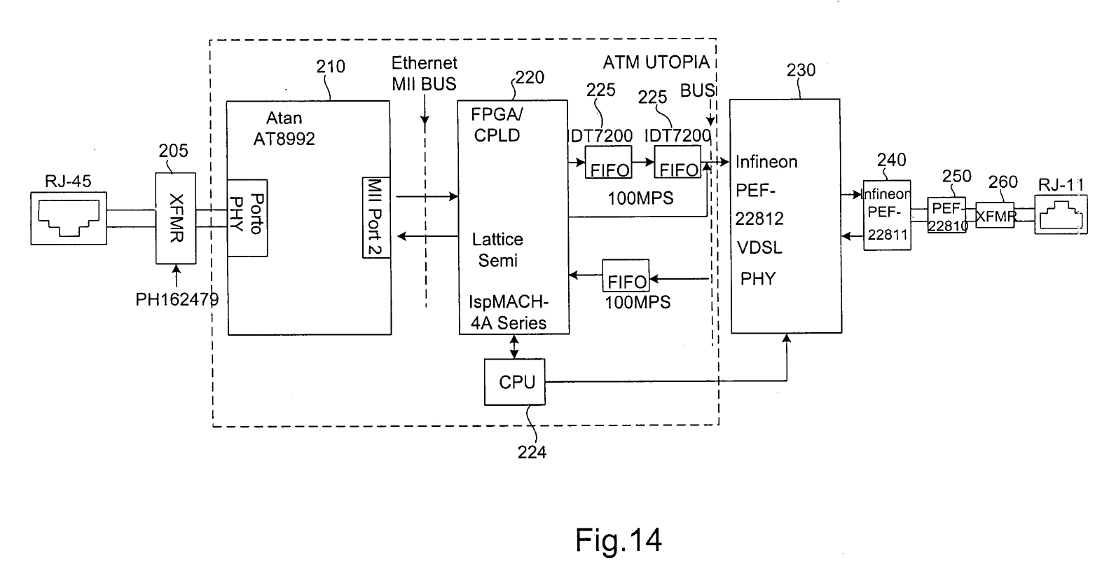

FIG. 14 shows another block diagram of an Ethernet to UTOPIA/VDSL design using off-the-shelf-components. The difference between the FIG. 13 and FIG. 14 is the Ethernet to UTOPIA/VDSL design converting Ethernet data packets into 9-byte sub-cell data field shown in FIG. 14 uses three FIFOs to process more data transmission.

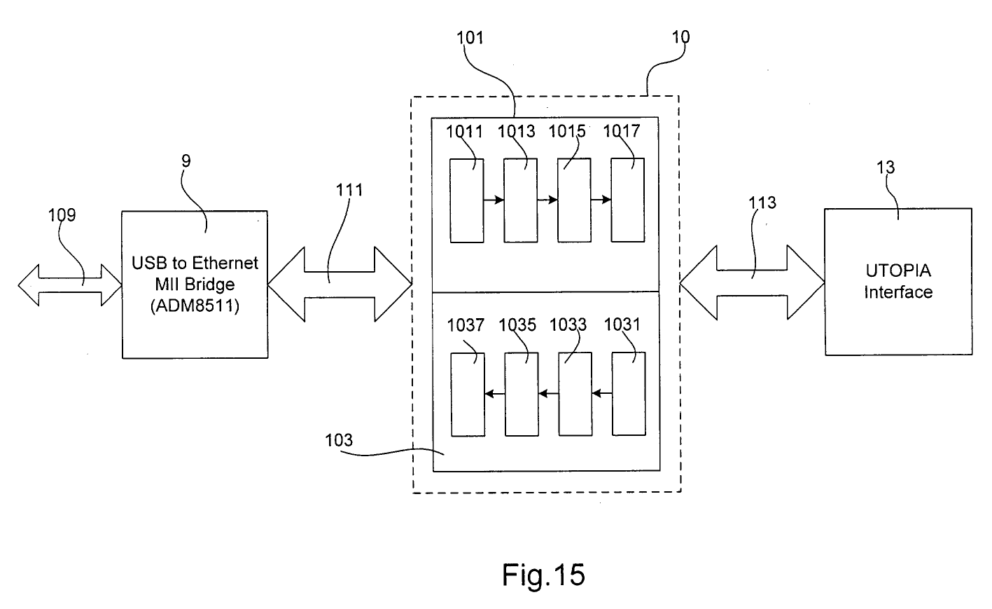

FIG. 15 shows another embodiment of the present invention. The embodiment Therefore, the present invention can be used as a USB to UTOPIA converter/bridge. The USB to Ethernet MII bridge can be found from off-the-shelf device such as ADM 8511.

It should be appreciated by one skilled in the art that the foregoing description is of exemplary embodiments only and is not intended to limit the scope, applicability, or configuration of the invention in any way. Rather, the foregoing description merely provides convenient illustrations for implementing various embodiments of the invention. For example, various changes may be made in the design and arrangement of the elements described in the exemplary embodiments herein without departing from the scope of the invention as set forth in the appended claims.

1. A converter/bridge respectively coupled to an Ethernet bus interface and a UTOPIA bus interface via a first bus and a second bus, comprising:
a first conversion device for receiving and converting Ethernet data packets over the first bus into 53-byte ATM cells over the second bus;
a second conversion device for receiving and converting 53-byte ATM cells over the second bus into Ethernet data packets over the first bus.

2. The converter/bridge of claim 1, wherein the Ethernet bus interface is selected from the group consisting of GPSI, MII, RMII, SMII, GMII, SS-SMII, TBI and other Ethernet interfaces.

3. The converter/bridge of claim 1, wherein the second bus is selected from the group consisting of UTOPIA level 1, level 2, level 3, and level 4 buses.

4. The converter/bridge of claim 1, further coupled Ethernet bus interface via a plurality of first buses, and further comprising an address decision unit on second bus for distinguishing a first bus to transmit and/or receive Ethernet data packets, said second bus being selected from the group consisting of UTOPIA level 2, level 3 and level 4.

5. The converter/bridge of claim 1, wherein the first conversion device further comprises:
a first conversion unit for converting first Ethernet data packets into first 4-nibble data fields, each first 4-nibble data field including a first 3-nibble data field and a first associated signal nibble;
an ATM Cell Buffer unit for combining a first group of twenty-four multiple first 4-nibble data field with a first 5-byte of header into a first 53-byte ATM cell, said header having an unused data field for out band management conveying the status and controlling a local and a remote node; and
a first transmitting unit for transmitting the first 53-byte ATM cell in ATM cell, and wherein the second conversion device further comprises:
a receiving unit for receiving a plurality of ATM Cell data, each ATM Cell including a group of twenty-four multiple 4-nibble data fields, each data field including a 3-nibble data field and an associated signal nibble, combined with a second 5-byte of header;
a second conversion unit for converting said ATM Cell data into a second Ethernet data packet; and
a second transmitting unit for transmitting the second Ethernet data packet in Ethernet packet format.

6. The converter/bridge of claim 5, wherein said first conversion unit includes a first flow control clock unit for slowing down an Ethernet transmitting speed, and said second conversion unit including a second flow control clock unit for slowing down an Ethernet receiving speed.

7. The converter/bridge of claim 1, wherein the first conversion device further comprises:
a first conversion unit for converting Ethernet data packets into first 9-byte data fields, each first 9-byte data field including a first 8-byte data field and a first associated signal byte;
an ATM Cell Buffer unit for combining a group of five multiple first 9-byte data fields with a first 5-byte of header and 3 reserved bytes into a first 53-byte ATM cell, said 3 reserved bytes being used for out band management conveying the status and controlling a local and a remote nodes; and
a first transmitting unit for transmitting the first 53-byte ATM cell in ATM cell format, and wherein the second conversion device further comprises:
a second receiving unit for receiving a plurality of ATM Cell data, each ATM Cell including a second group of five multiple second 9-byte data fields, each second 9 byte data fields including a second 8-byte data field and a second associated signal byte, combined with a second 5-byte of header and 3 reserved bytes; and
a second conversion unit for converting said ATM Cell data into a second Ethernet data packet; and
a second transmitting unit for transmitting the second Ethernet data packet in Ethernet packet format.

8. The converter/bridge of claim 7, wherein said first conversion unit includes a first flow control clock unit for slowing down an Ethernet transmitting speed, and said second control clock unit includes a second flow control clock unit for slowing down an Ethernet receiving speed.

9. The converter/bridge of claim 1, wherein each of said Ethernet data packets includes a preamble, a start delimiter, a destination address, a source address, a type field, a payload, and a error-checking code, said first conversion device further trimming said preamble and said delimiter of said Ethernet data packet and transmitting said destination address, said source address, said type field, said payload, and said error-checking code to said UTOPIA bus interface, said second conversion device further adding a preamble and a start delimiter in front of a data packet before transmitting to said Ethernet bus interface.

10. The converter/bridge of claim 1, further comprising a UTOPIA buffer for coupling to said UTOPIA bus interface and a second UTOPIA bus interface via a second bus and a third bus.

11. The converter/bridge of claim 1, further comprising a USB to Ethernet bridge coupled to said first bus and a USB.

12. A method for receiving and converting Ethernet packets over a first bus into 53-byte ATM cells over a second bus, comprising:
receiving and converting Ethernet data packets into 4-nibble data fields, each 4-nibble data field having a 3-nibble data field and an associated signal nibble;
combining a group of twenty-four multiple 4-nibble data fields with a 5-byte of header into a 53-byte ATM cell; and
transmitting the group of twenty-four multiple 4-nibble fields with the 5-byte of header in ATM cell format.

13. A method for receiving and converting Ethernet Packets over a first bus into 53-byte ATM cells over a second bus, comprising:
receiving and converting Ethernet data packets into 9-byte data fields, each 9 byte data field having an 8-byte data field and an associated signal byte;
combining a group of five multiple 9-byte data fields with a 5-byte of header and 3 reserved byte into a 53-byte ATM cell; and
transmitting the group of five 9-byte data fields with the 5-byte of header and 3 reserved bytes in ATM cell format.

14. A method for receiving and converting 53-byte ATM cells over a second bus into Ethernet packets over a first bus, comprising:
receiving a group of twenty-four multiple 4-nibble packets, each 4-nibble packet including a 3-nibble data packet and an associated signal nibble, combined with a 5-byte of header;
converting the group of twenty-four multiple 4-nibble packets and the 5-byte of header into twenty-four 4-nibble packets, each 4-nibble packet including the 3-nibble data and the associated signal nibble;
converting each 4-nibble packet into an Ethernet data packet; and
transmitting the Ethernet data packet in Ethernet packet format.

15. A method for receiving and converting 53-byte ATM cells over a second bus into Ethernet packets over a first bus, comprising:
receiving a group of five multiple 9-byte packets, each 9-byte packet including an 8-byte data packet and an associated signal byte, combined with a 5-byte of header and 3 reserved bytes;
converting the group of five multiple 9-byte packets and the 5-byte of header into five 9-byte packets;
converting each 9-byte packet into an Ethernet data packet; and
transmitting the Ethernet data packet format.
